(19) United States
(12) Patent Application Publication
(10) Pub. No.: US 2010/0232508 A1
(43) Pub. Date: Sep. 16, 2010

(54) CODING METHOD OF REDUCING INTERLAYER REDUNDANCY USING MITION DATA OF FGS LAYER AND DEVICE THEREOF

(76) Inventors: Jung-Won Kang, Seoul (KR); Tae-Meon Bae, Gwangju-city (KR); Cong-Thang Truong, Daejeon-city (KR); Jae-Gon Kim, Daejeon-city (KR); Yong-Man Ro, Daejeon-city (KR); Jin-Woo Hong, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/293,623

(22) PCT Filed: Mar. 23, 2007
(86) PCT No.: PCT/KR2007/001447

§ 371 Date: Sep. 19, 2008

(30) Foreign Application Priority Data
Mar. 24, 2006 (KR) 10-2006-0027030
Jul. 11, 2006 (KR) 10-2006-0065072
Jul. 12, 2006 (KR) 10-2006-0065475
Mar. 23, 2007 (KR) 10-2007-0028516

(51) Int. Cl. H04N 7/32; H04N 7/50

(52) U.S. Cl. 375/240.16; 375/E07.079

(57) ABSTRACT

Provided is a scalable video coding method and apparatus. Motion data of a high-quality fine grain scalability (FGS) layer is used for interlayer coding in order to remove redundancy between coarse grain scalability (CGS) layers or layers having different spatial resolutions, and information indicating that data of the FGS layer has been used for interlayer motion prediction is inserted for Moving Picture Expert Group (MPEG)-4 scalable video encoding. A bitstream extractor checks the information and performs extraction to maintain the data of the FGS layer. MPEG-4 scalable video decoding is performed using the information. By using the FGS layer, interlayer redundancy can be efficiently removed, thereby improving encoding efficiency.

### TECHNICAL FIELD

The present invention relates to a scalable video coding method and apparatus, and more particularly, to a scalable video encoding method, a bitstream extraction method, a video decoding method, and a video coding method and apparatus, in which data of a fine grain scalability (FGS) layer is used in a lower spatial layer when interlayer coding is performed in order to reduce redundancy between coarse grain scalability (CGS) layers or layers having different spatial resolutions.

### BACKGROUND ART

Recently, scalable video coding (SVC) has emerged as an important technique for video transmission in heterogeneous networks and terminal environments. In line with this, the Joint Video Team (JVT) of the International Organization for Standardization (ISO)/International Electrotechnical Commission (IEC) Moving Picture Expert Group (MPEG) and the International Telecommunication Union Technical standards group (ITU-T) Video Coding Expert Group (VCEG) has standardized SVC as an extension of H.264.

Currently standardized SVC (ITU-T and ISO/IEC JTC1, “Scalable Video Coding—Working Draft 2” JVT-0201, April 2005) provides a bitstream having scalability in terms of space, time, and quality, and can generate a different bitstream in terms of space, time, and quality by extracting a particular portion from an encoded bitstream based on instructions from a user terminal or a network condition. As such, an apparatus for extracting a bitstream having a variable scalability from an encoded scalable video bitstream is called a bitstream extractor.

In SVC, coding is performed for each layer with respect to video resolution in order to provide spatial scalability. Here, prediction between spatial layers, which hereinafter will be referred to as interlayer prediction, is performed in order to reduce redundancy data between the spatial layers.

Interlayer prediction includes interlayer texture prediction, interlayer motion prediction, and interlayer residual prediction, in which texture data, motion data, and residual data of a base quality layer other than an FGS layer is up-sampled to the resolution of an higher spatial layer in order to be used as prediction data of texture data, motion data, and residual data of the higher spatial layer.

When motion prediction is used in a layer representing a single spatial resolution, a motion mode exists for each macroblock or each sub-block and motion data exists for each motion mode.

### DESCRIPTION OF THE DRAWINGS

FIG. 1 is a block diagram of a coding system according to an exemplary embodiment of the present invention;

FIG. 2 illustrates interlayer motion prediction using motion data of a base layer;

FIG. 3 illustrates interlayer motion prediction using motion data of a fine grain scalability (FGS) layer;

FIG. 4 illustrates interlayer motion prediction using motion data of one of a base layer and an FGS layer;

FIG. 5 is a block diagram of a scalable video encoder according to an exemplary embodiment of the present invention;

FIGS. 6 to 10 illustrate signaling information inserted into a bitstream according to an exemplary embodiment of the present invention;

FIG. 11 is a block diagram of an encoder according to another exemplary embodiment of the present invention;

FIG. 12 is a block diagram of an extractor according to an exemplary embodiment of the present invention;

FIG. 13 is a block diagram of a decoder according to an exemplary embodiment of the present invention;

FIG. 14 is a flowchart of a scalable video encoding method according to an exemplary embodiment of the present invention;

FIG. 15 is a flowchart of a scalable video encoding method according to another exemplary embodiment of the present invention;

FIG. 16 is a flowchart of a process of selecting one of an FGS layer and a base layer as a prediction layer in a scalable video encoding method according to an exemplary embodiment of the present invention;

FIG. 17 is a flowchart of a bitstream extraction method according to an exemplary embodiment of the present invention;

FIG. 18 is a flowchart of a scalable video decoding method according to an exemplary embodiment of the present invention;

FIG. 19 is a block diagram of a scalable video codec according to an exemplary embodiment of the present invention;

FIG. 20 is a flowchart of a scalable video coding method according to an exemplary embodiment of the present invention; and

FIGS. 21A to 22D are graphs showing improvement in encoding efficiency during scalable video encoding according to an exemplary embodiment of the present invention.

### DETAILED DESCRIPTION OF THE INVENTION

### Technical Problem

The present invention provides a scalable video encoding method and apparatus, which improves encoding efficiency by using an FGS layer in a lower spatial layer for interlayer motion prediction.

The present invention also provides a scalable video encoding method and apparatus, which enables decoding using an FGS layer in a lower spatial layer by inserting information indicating that the FGS layer has been used into a bitstream when the bitstream is generated using the FGS layer for interlayer motion prediction.

The present invention also provides a bitstream extraction method and apparatus, which extracts a bitstream having a variable scalability from an original bitstream that is generated using an FGS layer in a lower spatial layer for interlayer motion prediction.

The present invention also provides a scalable video decoding method and apparatus, which performs decoding using data of an FGS layer of a bitstream that is generated using the FGS layer in a lower spatial layer for interlayer motion prediction.

The other objects and advantages of the present invention can be understood by the following description and will be made more apparent by embodiments of the present invention. Moreover, it can be easily understood that the objects and advantages of the present invention can be achieved by means claimed in the claims and combinations thereof.

### Technical Solution

The present invention improves encoding efficiency by using an FGS layer in a lower spatial layer for interlayer motion prediction.

### ADVANTAGEOUS EFFECTS

An encoding method according to the present invention uses motion data of a better display-quality FGS layer in a lower spatial layer than that of a base layer for interlayer motion prediction, thereby more efficiently reducing interlayer redundancy than interlayer motion prediction using the base layer and thus achieving higher encoding efficiency.

The encoding method according to the present invention also selects one of a base layer and an FGS layer in a lower spatial layer based on estimate values of bit rates generated during interlayer motion prediction for the base layer and the FGS layer and uses the selected one for interlayer motion prediction in order to avoid large overhead caused by the FGS layer, thereby achieving optimal encoding efficiency.

The encoding method according to the present invention also inserts into a bitstream signaling information indicating whether motion data of an FGS layer has been used for interlayer motion prediction in order to prevent the FGS layer from being removed during bitstream extraction, thereby allowing a decoder to normally reconstruct an image.

A bitstream extraction method according to the present invention checks signaling information indicating whether motion data of an FGS layer, which is inserted into a bitstream, has been used for interlayer motion prediction, and extracts a bitstream having a variable scalability, thereby allowing a decoder to normally reconstruct an image.

A decoding method according to the present invention can normally decode an image using motion data of a layer that is used for interlayer motion prediction, based on signaling information inserted into a bitstream.

The present invention can also be applied to SVC encoding and decoding with respect to coarse grain scalability (CGS) layers in the same manner as in SVC encoding and decoding with respect to layers having different spatial resolutions.

### BEST MODE

According to an aspect of the present invention, there is provided a scalable video encoding method including (a) transforming and quantizing a lower spatial layer of the original video, (b) performing motion prediction on an higher spatial layer of the original video using motion data of a fine granular scalability (FGS) layer in the transformed and quantized lower spatial layer, and (c) encoding the transformed and quantized lower spatial layer and the motion predicted higher spatial layer.

The scalable video encoding method may further include (d) inserting signaling information indicating that the FGS layer has been used for the motion prediction of the higher spatial layer into a bitstream including the encoded lower spatial layer and the encoded higher spatial layer.

According to another aspect of the present invention, there is provided a scalable video encoding method including (a) reconstructing the motion data of the FGS layer in the transformed and quantized lower spatial layer and (b) performing interlayer motion prediction by removing motion data that is redundant with the reconstructed motion data of the FGS layer from the higher spatial layer.

According to another aspect of the present invention, there is provided a scalable video encoding method including (a) transforming and quantizing a lower spatial layer of the original video, (b) performing motion prediction on an higher spatial layer of the original video using motion data of one of a base layer and a fine granular scalability (FGS) layer in the transformed and quantized lower spatial layer, which has a smaller estimate value of a bit rate generated during interlayer motion prediction, and (c) encoding the transformed and quantized lower spatial layer and the motion predicted higher spatial layer.

The scalable video encoding method may further include (d) if the FGS layer has been used for the motion prediction of the higher spatial layer, inserting signaling information indicating that the FGS layer has been used for the motion prediction of the higher spatial layer into a bitstream including the encoded lower spatial layer and the encoded higher spatial layer.

According to another aspect of the present invention, there is provided a scalable video encoding method including (a) reconstructing the motion data of one of the base layer and the FGS layer in the transformed and quantized lower spatial layer, which has a smaller estimate value of a bit rate generated during interlayer motion prediction and (b) performing interlayer motion prediction by removing motion data that is redundant with the reconstructed motion data of the FGS layer from the higher spatial layer.

According to another aspect of the present invention, there is provided a bitstream extraction method including (a) receiving a bitstream including signaling information indicating that a fine granular scalability (FGS) layer in a lower spatial layer has been used for motion prediction of an higher spatial layer, (b) extracting the signaling information from the bitstream, and (c) extracting a bitstream having a variable scalability based on the signaling information.

According to another aspect of the present invention, there is provided a scalable video decoding method including (a) receiving a bitstream having a variable scalability, which includes signaling information indicating that a fine grain scalability (FGS) layer in a lower spatial layer has been used for motion prediction of an higher spatial layer, (b) decoding the lower spatial layer, and (c) decoding the higher spatial layer using the decoded lower spatial layer based on the signaling information.

According to another aspect of the present invention, there is provided a scalable video coding method comprising (a) generating a bitstream including signaling information indicating that a fine grain scalability (FGS) layer in a lower spatial layer has been used for motion prediction of an higher spatial layer, (b) determining whether to remove the FGS layer of the lower spatial layer from the bitstream including the signaling information based on the signaling information and extracting a bitstream having a variable scalability, and (c) decoding the extracted bitstream based on the signaling information.

According to another aspect of the present invention, there is provided a scalable video encoding apparatus including a transformation and quantization unit transforming and quantizing a lower spatial layer of the original video, an interlayer prediction unit performing motion prediction on an higher spatial layer of the original video using motion data of a fine granular scalability (FGS) layer in the transformed and quantized lower spatial layer, and an encoding unit encoding the transformed and quantized lower spatial layer and the motion predicted higher spatial layer.

The scalable video encoding apparatus may further include a signaling unit inserting signaling information indicating that the FGS layer has been used for the motion prediction of the higher spatial layer into a bitstream including the encoded lower spatial layer and the encoded higher spatial layer.

According to another aspect of the present invention, there is provided a scalable video encoding apparatus including a reconstruction unit reconstructing the motion data of the FGS layer in the transformed and quantized lower spatial layer and a prediction unit performing interlayer motion prediction by removing motion data that is redundant with the reconstructed motion data of the FGS layer from the higher spatial layer.

According to another aspect of the present invention, there is provided a scalable video encoding apparatus including a transformation and quantization unit transforming and quantizing a lower spatial layer of the original video, an interlayer prediction unit performing motion prediction on an higher spatial layer of the original video using motion data of one of a base layer and a fine granular scalability (FGS) layer in the transformed and quantized lower spatial layer, which has a smaller estimate value of a bit rate generated during interlayer motion prediction, and an encoding unit encoding the transformed and quantized lower spatial layer and the motion predicted higher spatial layer.

The scalable video encoding apparatus may further include a signaling unit inserting signaling information indicating that the FGS layer has been used for the motion prediction of the higher spatial layer into a bitstream including the encoded lower spatial layer and the encoded higher spatial layer if the FGS layer has been used for the motion prediction of the higher spatial layer.

According to another aspect of the present invention, there is provided a scalable video encoding apparatus including a reconstruction unit reconstructing the motion data of one of the base layer and the FGS layer in the transformed and quantized lower spatial layer, which has a smaller estimate value of a bit rate generated during interlayer motion prediction, and a prediction unit performing interlayer motion prediction by removing motion data that is redundant with the reconstructed motion data of the FGS layer from the higher spatial layer.

According to another aspect of the present invention, there is provided a bitstream extraction apparatus including a reception unit receiving a bitstream including signaling information indicating that a fine granular scalability (FGS) layer in a lower spatial layer has been used for motion prediction of an higher spatial layer, an information extraction unit extracting the signaling information from the bitstream, and a bitstream extraction unit extracting a bitstream having a variable scalability based on the signaling information.

According to another aspect of the present invention, there is provided a scalable video decoding apparatus including a reception unit receiving a bitstream having a variable scalability, which includes signaling information indicating that a fine grain scalability (FGS) layer in a lower spatial layer has been used for motion prediction of an higher spatial layer and a decoding unit decoding the lower spatial layer and decoding the higher spatial layer using the decoded lower spatial layer based on the signaling information.

According to another aspect of the present invention, there is provided a scalable video coding apparatus including a bitstream generation unit generating a bitstream including signaling information indicating that a fine grain scalability (FGS) layer in a lower spatial layer has been used for motion prediction of an higher spatial layer, an extraction unit determining whether to remove the FG layer of the lower spatial layer from the bitstream including the signaling information based on the signaling information and extracting a bitstream having a variable scalability, and a decoding unit decoding the extracted bitstream based on the signaling information.

According to another aspect of the present invention, there is provided a computer-readable recording medium having recorded thereon a program for executing the scalable video encoding method, the bitstream extraction method, the scalable video decoding method, and the scalable video coding method.

### MODE FOR THE INVENTION

Hereinafter, exemplary embodiments of the present invention will now be described in detail with reference to the annexed drawings. It should be noted that like reference numerals refer to like elements throughout the specification. In the following description, a detailed description of known functions and configurations incorporated herein has been omitted for conciseness.

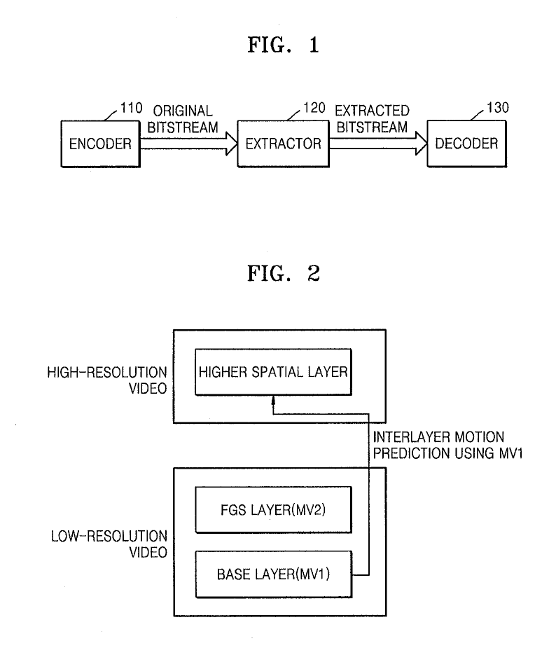

FIG. 1 is a block diagram of a coding system according to an exemplary embodiment of the present invention.

Referring to FIG. 1, the video coding system includes an encoder (scalable video encoding apparatus) 110, an extractor (bitstream extraction apparatus) 120, and a decoder (scalable video decoding apparatus) 130.

The encoder 110 performs interlayer prediction using data of a fine granular scalability (FGS) layer in a lower spatial layer for enhancing the spatial resolution of input video data, thereby generating a scalable video bitstream. The generated bitstream includes an encoded lower spatial layer and an encoded higher spatial layer. The encoder 110 inserts signaling information indicating that the data of the FGS layer has been used for interlayer prediction into the bitstream. Although signaling is performed with respect to a bitstream in the present invention, it may also be performed during encoding of the lower spatial layer and the higher spatial layer.

The extractor 120 extracts the signaling information from the scalable video bitstream and extracts a bitstream having a variable scalability based on the extracted signaling information. The extractor 120 may exist independently or may be combined with the encoder 110 or the decoder 130.

The decoder 130 decodes the extracted bitstream having a variable scalability.

For interlayer prediction, texture data and residual data of a lower spatial layer (including an FGS layer) are up-sampled to the resolution of an higher spatial layer in order to be used as prediction data of texture data and residual data of the higher spatial layer. For motion prediction, motion data of the lower spatial layer (except for the FGS layer) is up-sampled to the resolution of the higher spatial layer in order to be used as motion prediction data of the higher spatial layer.

In scalable video coding (SVC), different video data having different spatial resolutions are encoded for each spatial layer, thereby providing spatial resolution scalability. Here, interlayer motion prediction using motion data of the lower spatial layer as motion data of the higher spatial layer is used to reduce redundancy between the spatial layers.

FIG. 2 illustrates interlayer motion prediction using motion data of a base layer in the lower spatial layer.

Referring to FIG. 2, since different spatial layers have different spatial resolutions, a motion vector of the base layer has to be up-sampled in proportion to a difference between the resolution of the lower spatial layer and the resolution of an higher spatial layer. Here, a block to be encoded in the higher spatial layer does not require additional transmission of its motion vector, thereby improving coding efficiency.

However, in this case, a motion mode exists for each macroblock or each sub-block and single motion data exists for prediction of the higher spatial layer from the lower spatial layer.

Conventionally, motion data of the FGS layer has not been used because it may increase complexity in decoding. However, coding efficiency can be significantly improved by using the motion data of the FGS layer. Thus, by using the FGS layer for interlayer motion prediction, more motion data can be used in the lower spatial layer for interlayer motion prediction and interlayer redundancy can be efficiently reduced when the higher spatial layer uses motion data of the lower spatial layer.

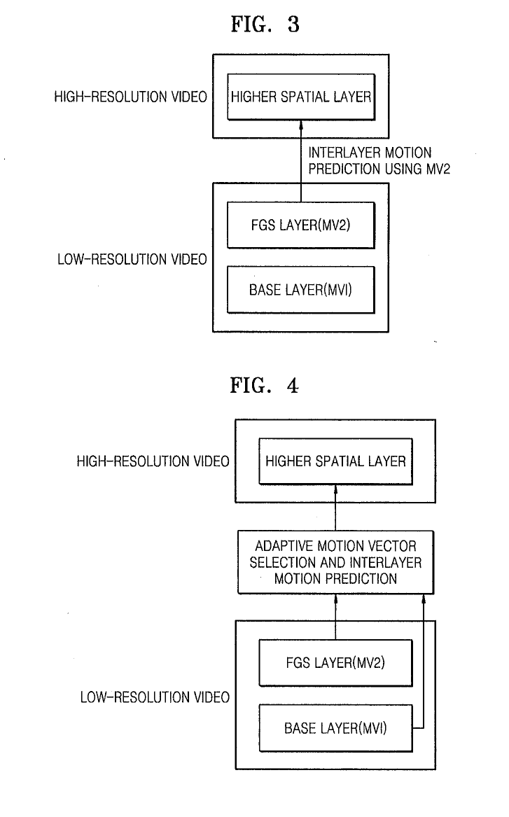

FIG. 3 illustrates interlayer motion prediction using the motion data of the FGS layer in the lower spatial layer.

Referring to FIG. 3, interlayer motion prediction can be performed using the motion data of the FGS layer in the lower spatial layer including the base layer and the FGS layer.

Since at least one layer having the same spatial resolution may exist in the lower spatial layer, at least one motion mode may exist for each macroblock or each sub-block in a spatial layer representing a single spatial resolution. In this sense, at least one motion data item may be available in the lower spatial layer.

Thus, when the motion data of the high-quality FGS layer is used instead of the motion data of the standard-quality base layer, the better quality motion data than that of the base layer is used for interlayer prediction, thereby efficiently reducing interlayer redundancy and thus improving encoding efficiency.

Information indicating which one of the motion data of the FGS layer and the motion data of the base layer is used for interlayer motion prediction may be inserted into the bitstream, as will be described later.

FIG. 4 illustrates interlayer motion prediction using the motion data of one of the base layer and the FGS layer in the lower spatial layer.

Referring to FIG. 4, encoding is performed using one of a motion vector of the base layer and a motion vector of the FGS layer, which has higher encoding efficiency.

When the FGS layer is added to the lower spatial layer, a bit rate may increase and thus interlayer motion prediction using the FGS layer as illustrated in FIG. 4 may increase overhead. For this reason, one of the motion data of the FGS layer and the motion data of the base layer is selected by comparing the efficiency of encoding using the motion data of the FGS layer with the efficiency of encoding using the motion data of the base layer, thereby performing encoding at an optimal bit rate.

At this time, information indicating which one of the motion data of the FGS layer and the motion data of the base layer is used for interlayer motion prediction may be inserted into the bitstream, as will be described later.

Encoding and decoding according to the present invention are the same as in Moving Picture Expert Group (MPEG)-4 SVC except for the use of data of an FGS layer in interlayer motion prediction.

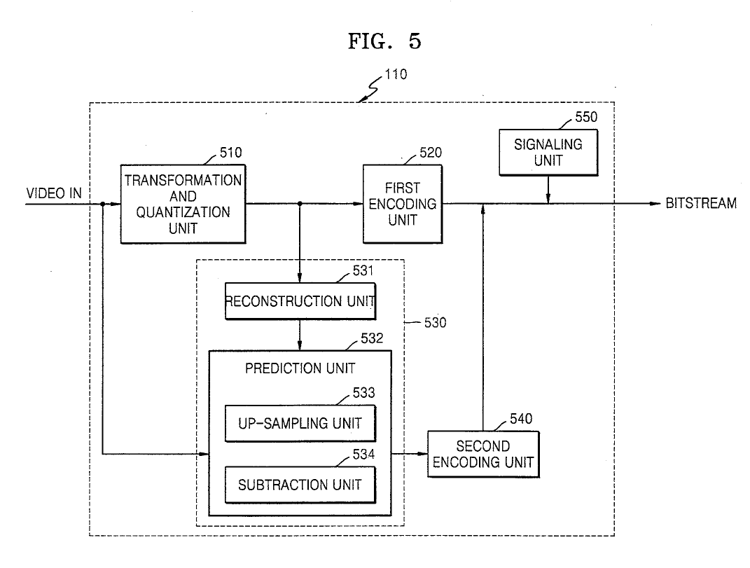

FIG. 5 is a detailed block diagram of the encoder 110 according to an exemplary embodiment of the present invention. A structure of the encoder 110, which has the same function as that of a well-known structure, will not be described herein.

Referring to FIG. 5, the encoder 110 includes a transformation and quantization unit 510, a first encoding unit 520, an interlayer prediction unit 530, a second encoding unit 540, and a signaling unit 550. The interlayer prediction unit 530 includes a reconstruction unit 531 and a prediction unit 532.

The transformation and quantization unit 510 transforms and quantizes a lower spatial layer of the original video data (input video data that has not yet been encoded).

The first encoding unit 520 encodes the transformed and quantized low-resolution lower spatial layer. The lower spatial layer has a particular resolution and may include at least one layer. For example, the lower spatial layer may include a standard-quality base layer and a high-quality FGS layer.

The interlayer prediction unit 530 performs motion prediction on an higher spatial layer of the original video using motion data of an FGS layer in the transformed and quantized lower spatial layer.

The reconstruction unit 531 reconstructs motion data of the transformed and quantized FGS layer. Since the FGS layer has higher quality than a base layer, interlayer redundancy can be reduced efficiently and thus high encoding efficiency can be achieved.

The prediction unit 532 performs interlayer motion prediction by removing the motion data of the higher spatial layer, which is redundant with the reconstructed motion data of the FGS layer. The prediction unit 532 includes an up-sampling unit 533 and a subtraction unit 534. The up-sampling unit 533 up-samples the reconstructed motion data of the FGS layer to the resolution of the higher spatial layer. The subtraction unit 534 then subtracts the up-sampled motion data of the FGS layer from the motion data of the higher spatial layer of the original video, thereby removing the redundant motion data.

Motion prediction between spatial layers, i.e., interlayer motion prediction, is performed between each frame of the higher spatial layer and each frame of the lower spatial layer, which temporally corresponds to the frame of the higher spatial layer, i.e., is reproduced at the same point of time as the frame of the higher spatial layer. Each frame includes at least one block and motion data exists for each block.

The second encoding unit 540 encodes the higher spatial layer that is motion predicted by the prediction unit 532 by subtraction of the redundant motion data.

The first encoding unit 520 and the second encoding unit 530 may function separately or as one.

The signaling unit 550 inserts signaling information indicating that the motion data of the FGS layer has been used for motion prediction of the higher spatial layer into a bitstream including the encoded lower spatial layer and the encoded higher spatial layer.

When the motion data of the FGS layer in the lower spatial layer is used in interlayer prediction for motion prediction of the higher spatial layer, data of the FGS layer cannot be used when a decoder decodes the higher spatial layer if the FGS layer is removed.

To solve the problem, when the motion data of the FGS layer is used in interlayer prediction, signaling for preventing the FGS layer from being removed is required during bitstream extraction.

In the present invention, when the FGS layer is used in motion prediction of the higher spatial layer, signaling can be performed by (1) inserting signaling information into a payload of a bitstream or (2) inserting signaling information into a header of a bitstream.

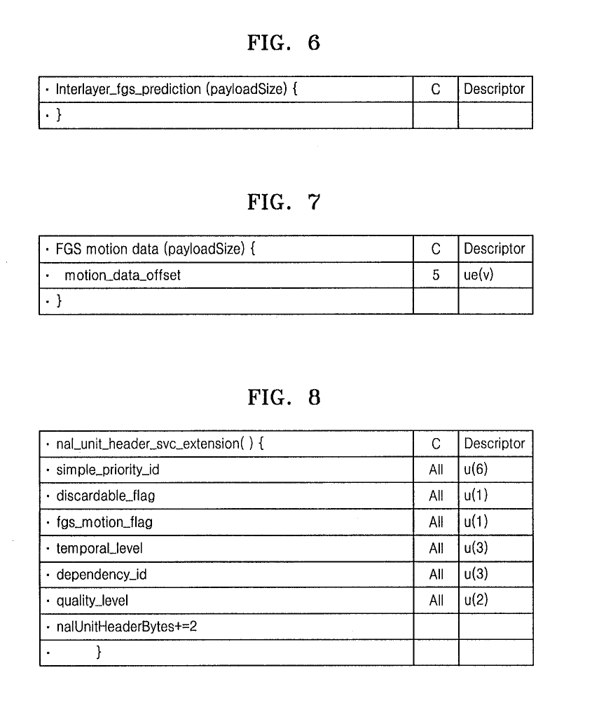

The first signaling method is as illustrated in FIGS. 6 and 7 and the second method is as illustrated in FIGS. 8 to 10.

The first signaling method can be implemented by i) inserting a flag indicating that interlayer motion prediction has been performed using the motion data of the FGS layer into a block of the motion predicted higher spatial layer, ii) inserting SEI metadata indicating that interlayer motion prediction has been performed using the motion data of the FGS layer before an IDR frame that is previous and nearest to a frame of the motion predicted higher spatial layer, or iii) inserting SEI metadata regarding a motion data offset that provides information about the motion data of the FGS layer before an NAL (Network Abstraction Layer) unit of the FGS layer.

In the case of flag insertion, interlayer_fgs_prediction_flag may be added to a bitstream as a flag. In this case, interlayer_fgs_prediction_flag may be set to 1 if interlayer motion prediction is performed using the motion data of the FGS layer. Otherwise, interlayer_fgs_prediction_flag may be set to 0. The flag may be added to each block of the higher spatial layer that is motion predicted using the FGS layer. If the flag is set to 1, the extractor 120 may extract the bitstream without removing an FGS layer corresponding to each block.

In the case of SEI metadata insertion, the SEI metadata may exist in a position that allows a decoder to recognize a change of an interlayer motion prediction method. Thus, the SEI metadata may be positioned before a key picture in a state immediately previous to the change of the interlayer motion prediction method.

FIG. 6 illustrates an example in which SEI metadata is inserted before an IDR frame that is previous and nearest to a frame of the higher spatial layer that is motion predicted using the FGS layer. Referring to FIG. 6, if interlayer_fgs_prediction SEI is inserted into a bitstream, a bitstream between an IDR frame immediately following the SEI data and a frame immediately preceding a next IDR frame is regarded as being interlayer motion predicted using the motion data of the FGS layer. Thus, the extractor 120 that checks the SEI metadata can extract the bitstream without removing an FGS layer corresponding to the higher spatial layer.

FIG. 7 illustrates an example in which SEI metadata is inserted before an NAL unit of the FGS layer. Referring to FIG. 7, FGS_motion_data SEI is inserted before an FGS NAL unit. The SEI metadata is information about the motion data of the FGS layer, and motion_data_offset indicates the number of bytes (offset) counted from the first byte of an FGS NAL unit to the last byte including the motion data of the FGS layer. Thus, when at least one NAL unit having higher dependency_id (symbol indicating a spatial resolution level) than the FGS NAL unit exists in a bitstream, a portion from the start of the FGS NAL unit to the offset may not be removed during bitstream extraction.

The second signaling method may be implemented by i) inserting a flag indicating that the motion data of the FGS layer has been included into a header of an NAL unit containing the motion data of the FGS layer used for interlayer motion prediction, ii) assigning a specific value indicating priority in order to indicate that the motion data of the FGS layer is included to the header of the NAL unit, or iii) inserting a flag indicating that the motion data of the FGS layer has been used for interlayer motion prediction into a slice header.

FIG. 8 illustrates an example in which a flag is inserted into the header of the NAL unit. Referring to FIG. 8, fgs_motion_flag is inserted into the header of the NAL unit in order to indicate that the motion data of the FGS layer is included in the header of the NAL unit.

More specifically, a single FGS fragment containing the motion data of the FGS layer used as a prediction layer, i.e., a layer used for interlayer motion prediction, in the lower spatial layer in order to generate an independent NAL unit. In order to indicate that the NAL unit is the FGS fragment containing the motion data of the FGS layer, a flag named “fgs_motion_flag” is added to the header of the NAL unit for signaling. In this case, a NAL unit having fgs_motion_flag=1 is not removed (extracted) when at least one NAL unit having higher dependency_id exists in a bitstream and a NAL unit having fgs_motion_flag=0 may be removed.

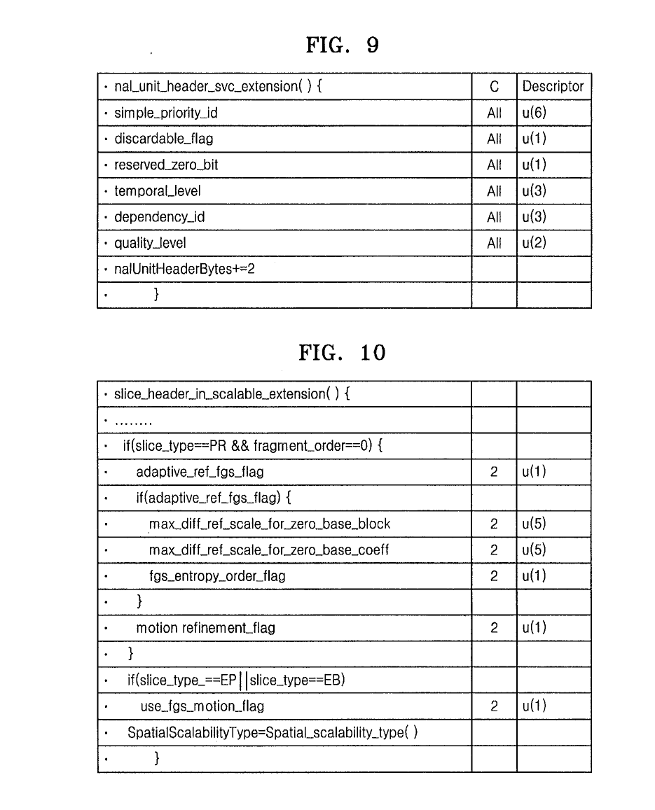

FIG. 9 illustrates an example in which a specific value indicating priority is inserted into the header of the NAL unit in order to indicate that the motion data of the FGS layer is included in the header of the NAL unit. Referring to FIG. 9, when a predetermined value, e.g., “63”, is assigned to simple_prioriti_id of the header of the NAL unit for signaling, an NAL unit having simple_priority_id=63 and quality_level (symbol indicating a quantization level in a single spatial layer)#0, i.e., the NAL unit of the FGS layer, may not be extracted when at least one NAL unit having higher dependency_id exists in a bitstream.

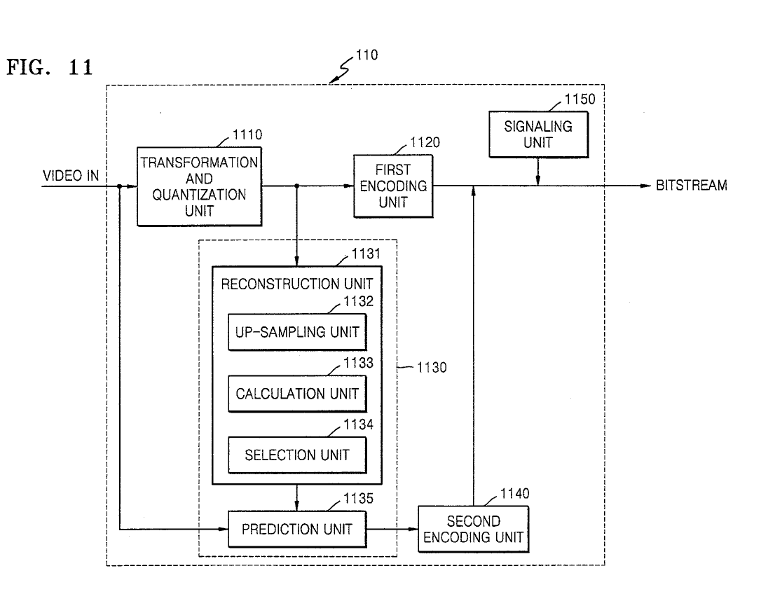

FIG. 10 illustrates an example in which a flag indicating that the motion data of the FGS layer has been used for interlayer motion prediction is inserted into a slice header. Referring to FIG. 10, use_fgs_motion_flag is added to a slice header of the motion predicted higher spatial layer in order to indicate that the motion data of the FGS layer is used for interlayer prediction. In this case, if use_fgs_motion_flag is set to 1, it means that the motion data of the FGS layer is used for motion prediction of the higher spatial layer, thereby preventing the FGS layer from being removed. If use_fgs_motion_flag is set to 0, it means that the motion data of the FGS layer is not used for motion prediction of the higher spatial layer.

FIG. 11 is a block diagram of the encoder 110 according to another exemplary embodiment of the present invention. A structure of the encoder 110, which has the same function as that of a well-known structure, will not be described herein.

Referring to FIG. 11, the encoder 110 includes a transformation and quantization unit 1110, a first encoding unit 1120, an interlayer prediction unit 1130, a second encoding unit 1150, and a signaling unit 1160. The interlayer prediction unit 1130 includes a reconstruction unit 1131 and a prediction unit 1135.

The transformation and quantization unit 1110 transforms and quantizes a lower spatial layer of the original video.

The first encoding unit 1120 encodes the transformed and quantized low-resolution lower spatial layer. The lower spatial layer has a particular spatial resolution and may include at least one layer. For example, the lower spatial layer may include a standard-quality base layer and a high-quality FGS layer.

The interlayer prediction unit 1130 performs motion prediction on an higher spatial layer of the original video using motion data of one of the base layer and the FGS layer in the transformed and quantized lower spatial layer, which has a smaller estimate value of a bit rate generated during interlayer motion prediction.

The reconstruction unit 1131 reconstructs the motion data of one of the base layer and the FGS layer, which has a smaller estimate value of a bit rate generated during interlayer motion prediction. The reconstruction unit 1131 includes an up-sampling unit 1132, a calculation unit 1133, and a selection unit 1134.

The up-sampling unit 1132 up-samples a motion vector of each of the base layer and the FGS layer in the lower spatial layer to the resolution of the higher spatial layer. The calculation unit 1133 calculates a bit rate generated during interlayer motion prediction for each of the base layer and the FGS layer.

The selection unit 1134 selects one of the base layer and the FGS layer, which has a smaller bit rate, as a prediction layer. If the bit rates for the base layer and the FGS layer are the same as each other, it is desirable to select the base layer as the prediction layer.

The prediction unit 1135 subtracts the motion data of the up-sampled and reconstructed lower spatial layer (the base layer or the FGS layer) from the motion data of the higher spatial layer of the original video, thereby removing redundant motion data.

Interlayer motion prediction is performed between each frame of the higher spatial layer and each frame of the lower spatial layer, which temporally corresponds to the frame of the higher spatial layer, i.e., is reproduced at the same point of time as the frame of the higher spatial layer. Each frame includes at least one block and motion data exists for each block.

The second encoding unit 1140 encodes the higher spatial layer that is motion predicted by the prediction unit 1135.

The first encoding unit 1120 and the second encoding unit 1140 may function separately or as one.

The signaling unit 1150 inserts information indicating that the motion data of the FGS layer has been used for interlayer motion prediction into a bitstream including the encoded lower spatial layer and the encoded higher spatial layer. Signaling may be performed in ways described with reference to FIGS. 5 to 10.

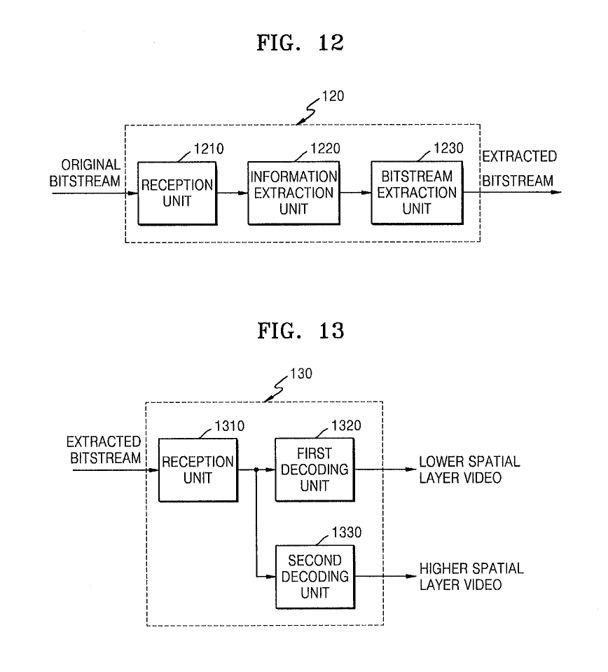

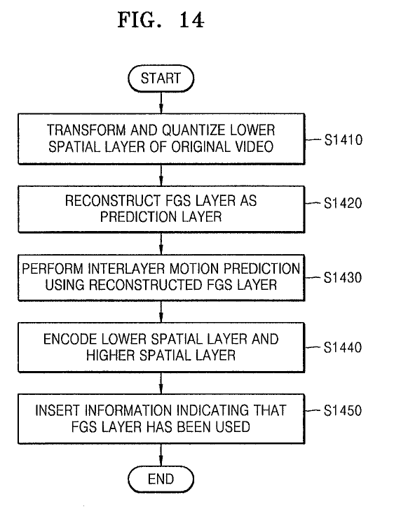

FIG. 12 is a detailed block diagram of the extractor 120 according to an exemplary embodiment of the present invention.

The extractor 120 includes a reception unit 1210, an information extraction unit 1220, and a bitstream extraction unit 1230. The extractor 120 may be added to an output unit of the encoder 110 or an input unit of the decoder 130.

The reception unit 1210 receives a bitstream including a lower spatial layer and an higher spatial layer. The lower spatial layer has a particular spatial resolution and includes a base layer and an FGS layer. The higher spatial layer is generated by interlayer motion predicting one of the base layer and the FGS layer selected in the lower spatial layer as a prediction layer. If the FGS layer is used for interlayer motion prediction, signaling information indicating that the FGS layer has been used for interlayer motion prediction is inserted into the bitstream.

The information extraction unit 1220 extracts and checks the signaling information inserted into the bitstream.

The bitstream extraction unit 1230 extracts a bitstream having a variable scalability by determining whether to remove the FGS layer based on the signaling information. If the higher spatial layer is encoded by interlayer motion prediction using the FGS layer, the decoder 130 has to perform decoding using the FGS layer. Thus, if the signaling information indicating that interlayer motion prediction has been performed using the motion data of the FGS layer is checked, the bitstream extraction unit 1230 extracts the bitstream without removing the FGS layer.

The signaling information may be extracted from a payload or a header of the bitstream.

When the signaling information is a flag inserted into each block of the higher spatial layer, the bitstream extraction unit 1230 extracts the bitstream without removing the FGS layer that temporally corresponds to each block of the higher spatial layer, i.e., is reproduced at the same point of time as each block of the higher spatial layer, if the flag is set. For example, if interlayer_fgs_prediction_flag is set to 1 in the bitstream, it is regarded that interlayer motion prediction has been performed using the motion data of the FGS layer. Thus, the bitstream extraction unit 1230 extracts the bitstream without removing the FGS layer.

When the signaling information is SEI metadata inserted before an IDR frame of the higher spatial layer, the bitstream extraction unit 1230 extracts the bitstream without removing an FGS layer that temporally corresponds frames from the IDR frame to a frame immediately previous to a next IDR frame. For example, if interlayer_fgs_prediction SEI is confirmed in the bitstream, it is regarded that a bitstream from an IDR frame immediately following the SEI metadata to a frame immediately previous to a next IDR frame has been interlayer motion predicted using the motion data of the FGS layer. Thus, the bitstream extraction unit 1230 extracts the bitstream without removing the FGS layer.

When the signaling information is SEI metadata regarding a motion data offset, which is inserted before an FGS NAL unit that is an NAL unit of the FGS layer, the bitstream extraction unit 1230 extracts the bitstream without removing the start byte of the NAL unit through the last byte including the motion data. For example, if motion_data_offset is confirmed in FGS_motion_data SEI, the bitstream extraction unit 1230 extracts the bitstream without removing any of the first byte of the FGS NAL unit before which the SEI metadata is inserted through the last byte of the FGS NAL unit including the motion data of the FGS layer.

When the signaling information is a flag inserted into a header of an NAL unit that is an FGS fragment containing the motion data of the FGS layer, the bitstream extraction unit 1230 extracts the bitstream without removing the NAL unit if the flag is set. For example, if a flag named “fgs_motion_flag” exits in the header of the NAL unit containing the motion data of the FGS layer and the flag is set to 1, the bitstream extraction unit 1230 does not remove the NAL unit that is containing the FGS fragment when at least one NAL unit having a higher dependency_id exists in the bitstream.

When the signaling information is a particular value indicating priority, which is inserted into a header of an NAL unit that is containing an FGS fragment containing the motion data of the FGS layer, the bitstream extraction unit 1230 extracts the bitstream without removing an NAL unit having the particular value. For example, if a particular value, e.g., “63”, is assigned to simple_prioriti_id in the header of the NAL unit that is containing the FGS fragment and quality_level is not “0”, the bitstream extraction unit 1230 does not remove the NAL unit that is containing the FGS fragment when at least one NAL unit having a higher dependency_id exists in the bitstream.

If the signaling information is a flag inserted into a header of a slice of the higher spatial layer, the bitstream extraction unit 1230 extracts the bitstream without removing the FGS layer corresponding to the slice when the flag is set. For example, if use_fgs_motion_flag is set to 1 in the header of the slice of the higher spatial layer, it is determined that the motion data of the FGS layer has been used for interlayer motion prediction. Thus, the bitstream extraction unit 1230 does not remove the FGS layer.

FIG. 13 is a detailed block diagram of the decoder 130 according to an exemplary embodiment of the present invention.

Referring to FIG. 13, the decoder 130 includes a reception unit 1310, a first decoding unit 1320, and a second decoding unit 1330.

The reception unit 1310 receives a bitstream having a variable scalability. The received bitstream is an output of the extractor 120 that extracts signaling information indicating that an FGS layer has been used for interlayer motion prediction from a bitstream including a lower spatial layer and an higher spatial layer and then extracts a bitstream having a variable scalability after determining whether to remove the FGS layer based on the signaling information.

The first decoding unit 1220 decodes the lower spatial layer of the bitstream in order to reconstruct the original lower spatial layer video.

The second decoding unit 1230 decodes the higher spatial layer based on motion data of a layer used for interlayer motion prediction among layers of the lower spatial layer, thereby reconstructing the original higher spatial layer video.

FIG. 14 is a flowchart of a scalable video encoding method according to an exemplary embodiment of the present invention. In the following description, redundant description with the above description will be omitted.

Referring to FIG. 14, a lower spatial layer of the original video is transformed and quantized in operation S1410. According to FGS scalability, the lower spatial layer may include a standard-quality base layer and a high-quality FGS layer that have the same spatial resolution.

Next, the FGS layer in the transformed and quantized lower spatial layer is selected as a prediction layer for interlayer motion prediction and then decoded, thereby being reconstructed, in operation S1420.

Motion prediction is performed on an higher spatial layer using the reconstructed FGS layer in operation S1430.

The motion predicted higher spatial layer and the transformed and quantized lower spatial layer are encoded in operation S1440.

Signaling information indicating that the FGS layer has been used for interlayer motion prediction is inserted into a bitstream including the encoded lower spatial layer and the encoded higher spatial layer in operation S1450. The insertion of the signaling information may be performed as described with reference to FIGS. 5 to 10.

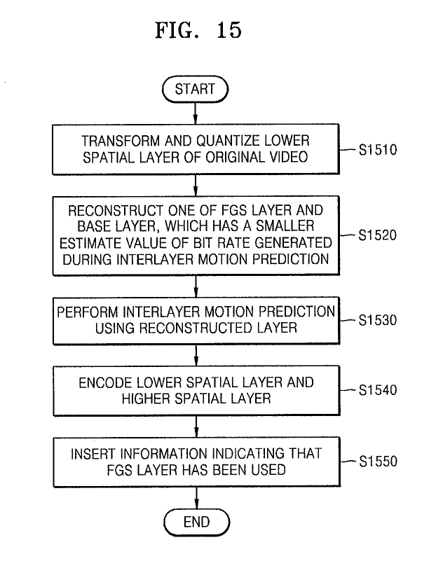

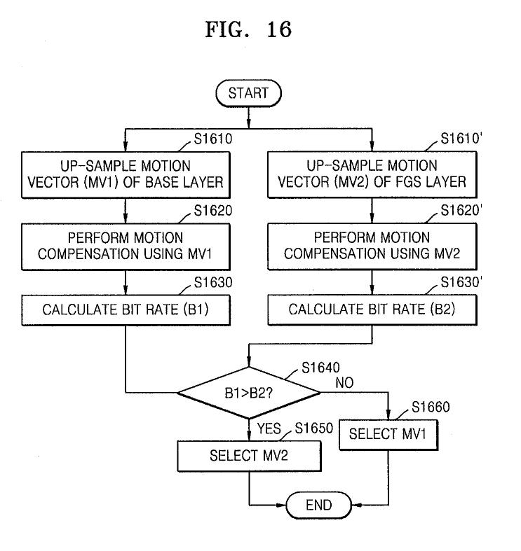

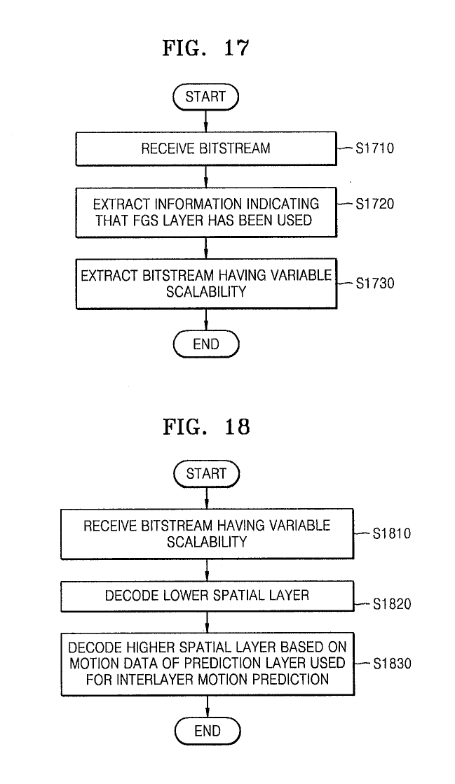

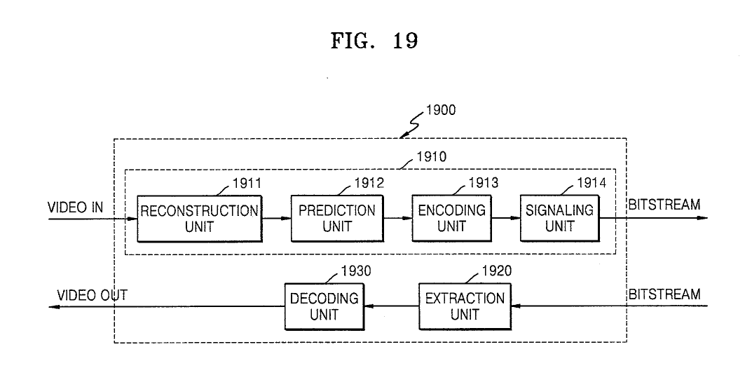

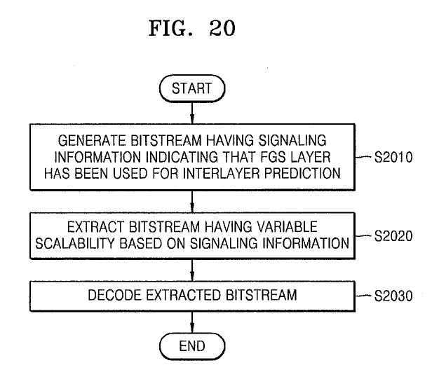

FIG. 15 is a flowchart of a scalable video encoding method according to another exemplary embodiment of the present invention. Redundant description with the above description will be omitted in the following description.

Referring to FIG. 15, a lower spatial layer of the original video is transformed and quantized in operation S1510. According to FGS scalability, the lower spatial layer may include a standard-quality base layer and a high-quality FGS layer that have the same spatial resolution.

Next, one of the base layer and the FGS layer in the transformed and quantized lower spatial layer is selected as a prediction layer for interlayer motion prediction and is decoded, thereby being reconstructed, in operation S1520. The selection of the prediction layer is performed by selecting one of the base layer and the FGS layer, which has a smaller estimate value of a bit rate generated during interlayer motion prediction using a motion vector of each of the base layer and the FGS layer. When the estimate values of the bit rates for the base layer and the FGS layer are the same, it is desirable to select the base layer as the prediction layer.

FIG. 16 is a flowchart of a process of selecting the prediction layer using bit rate calculation.

Referring to FIG. 16, a motion vector MV1 of the base layer is up-sampled to the resolution of the higher spatial layer in operation S1610 and a motion vector MV2 of the FGS layer is up-sampled to the resolution of the higher spatial layer in operation S1610′.

In operations S1620 and S1620′, motion compensation is performed using each of the motion vectors MV1 and MV2.

A bit rate B1 according to the use of the motion vector MV1 for motion compensation and a bit rate B2 according to the use of the motion vector MV2 for motion compensation are calculated in operations S1630 and S1630′.

The bit rate B1 is compared with the bit rate B2 in order to determine whether the bit rate B1 is greater than the bit rate B2 in operation S1640.

In the case of B1>B2, the motion vector MV2 is selected for interlayer motion prediction in operation S1650.

In the case of B1<B2 or B1=B2, the motion vector MV1 is selected for interlayer motion prediction in operation S1660.

Referring back to FIG. 15, interlayer motion prediction is performed on the higher spatial layer using the reconstructed prediction layer in operation S1530.

The motion predicted higher spatial layer and the transformed and quantized lower spatial layer are encoded in operation S1540.

Signaling information indicating that the FGS layer has been used for interlayer motion prediction is inserted into the bitstream including the encoded lower spatial layer and the encoded higher spatial layer in operation S1450. The insertion of the signaling information may be performed as described with reference to FIGS. 5 to 10.

FIG. 17 is a flowchart of a bitstream extraction method according to an exemplary embodiment of the present invention. Redundant description with the above description will be omitted in the following description.

Referring to FIG. 17, the extractor 120 receives a bitstream including a lower spatial layer and an higher spatial layer in operation S1710. Signaling information indicating that an FGS layer in the lower spatial layer has been used for motion prediction of the higher spatial layer is inserted the bitstream.

Next, the signaling information is extracted in operation S1720. The signaling information is such as a flag or SEI metadata indicating whether the encoder 110 has used a base layer or the FGS layer of the lower spatial layer for interlayer prediction and is inserted into a payload or a header of the bitstream. The signaling information has already been described with reference to FIGS. 5 to 10.

If it is determined that the FGS layer has been used for interlayer motion prediction based on the signaling information, the extractor 120 does not remove the FGS layer, thereby extracting a bitstream having a variable scalability in operation S1730. Detailed description of the method of extracting a bitstream extractor 120 has already been provided in description with reference to FIG. 12.

FIG. 18 is a flowchart of a scalable video decoding method according to an exemplary embodiment of the present invention. Redundant description with the above description will be omitted in the following description.

Referring to FIG. 18, the decoder 130 receives a bitstream extracted by the extractor 120 in operation S1810. The bitstream is a bitstream having a variable scalability, which is extracted after determination of whether to remove an FGS layer based on signaling information indicating whether the FGS layer has been used for interlayer motion prediction, which is inserted during generation of the bitstream.

The decoder 130 decodes a lower spatial layer of the received bitstream in operation S1820.

In operation S1830, the higher spatial layer is decoded based on motion data of a layer (a base layer or an FGS layer) corresponding to a prediction layer selected in the decoded lower spatial layer based on the signaling information.

FIG. 19 is a block diagram a coding apparatus (a scalable video codec) 1900 according to an exemplary embodiment of the present invention.

Referring to FIG. 19, the coding apparatus 1900 includes a bitstream generation unit 1910, an extraction unit 1920, and a decoding unit 1930. Redundant description with the above description will be omitted in the following description.

The bitstream generation unit 1910 includes a reconstruction unit 1911, a prediction unit 1912, an encoding unit 1913, and a signaling unit 1914.

The reconstruction unit 1911 selects an FGS layer in the transformed and quantized lower spatial layer as a prediction layer that provides motion data to be used for interlayer motion prediction or selects one of a base layer and an FGS layer in the transformed and quantized lower spatial layer, which has a smaller estimate value of a bit rate generated during interlayer motion prediction, as the prediction layer and reconstructs the selected prediction layer.

The prediction unit 1912 performs interlayer motion prediction by removing motion data that is redundant with motion data of the reconstructed prediction layer from the higher spatial layer of the original video.

The encoding unit 1913 encodes the motion predicted higher spatial layer and the transformed and quantized lower spatial layer.

When the FGS layer is selected as the prediction layer, the signaling unit 1914 signals information indicating that the FGS layer is used as the prediction layer to the bitstream.

The extraction unit 1920 extracts signaling information indicating that the FGS layer has been used for interlayer motion prediction from the input bitstream. If the FGS layer is used as the prediction layer, the extraction unit 1920 extracts a bitstream without removing the FGS layer, thereby extracting a bitstream having a variable scalability.

The decoding unit 1930 decodes the extracted bitstream using motion data of a layer (a base layer or an FGS layer) corresponding to the prediction layer based on the signaling information.

FIG. 20 is a flowchart of a scalable video coding method according to an exemplary embodiment of the present invention. Redundant description with the above description will be omitted in the following description.

Referring to FIG. 20, a bitstream including a lower spatial layer and an higher spatial layer generated using the lower spatial layer for interlayer motion prediction is generated in operation S2010.

More specifically, the transformed and quantized FGS layer is selected as a prediction layer that provides motion data used for motion prediction of the higher spatial layer or one of the transformed and quantized base layer and the transformed and quantized FGS layer, which has a smaller estimate of a bit rate generated during interlayer motion prediction, is selected as the prediction layer, and the prediction layer is reconstructed. Next, motion data that is redundant with motion data of the reconstructed prediction layer is removed from the higher spatial layer, thereby performing interlayer motion prediction. The transformed and quantized prediction layer and the motion predicted higher spatial layer are encoded. When the FGS layer is selected as the prediction layer, signaling information indicating that the FGS layer is used as the prediction layer is inserted into the bitstream.

It is determined whether to remove the FGS layer from the input bitstream based on the signaling information and a bitstream having a variable scalability is extracted in operation S2020.

By using motion data of a layer (the base layer or the FGS layer) corresponding to a layer used for interlayer motion prediction based on the signaling information, the extracted bitstream is decoded in operation S2030.

Table 2 through Table 4B show results of bit rate reduction experiments when interlayer prediction is performed using motion data of an FGS layer.

Table 1 shows conditions of the experiments. In each of the experiments, the size of each group of pictures (GOP) is 16, each bitstream is encoded into two spatial layers, i.e., a Quarter Common Intermediate Format (QCIF) layer as a low-resolution layer and a CIF layer as a high-resolution layer, and each of the spatial layers includes 3 FGS layers. In each of the experiments, a parameter of the CIF layer does not change and a frame rate and a quantization parameter (QP) of the QCIF layer change. In addition, in each of the experiments, we compute the bit rate reduction of the bitstreams provided by the present invention with respect to the bitstreams provided by JSVM 5.7.

TABLE 1

| | QP | Frame Rate |
|---|---|---|
| Experiment 1 | JVT-Q205 | QCIF@15fps, CIF@30fps |
| Experiment 2 | JVT-Q205 | QCIF@30fps, CIF@30fps |
| Experiment 3 | Higher QP for QCIF layer | QCIF@15fps, CIF@30fps |
| | increases | |

### Experiment 1

In experiment 1, a conventional test configuration (JVT-Q205) has been applied to encode a bitstream. Table 2 shows a bit rate reduction calculated for a base layer and 3 FGS layers for each content of the CIF layer using a percentage unit. A bit rate of the QCIF layer does not change and thus is not shown in Table 1.

TABLE 2

| Layer | BUS | SOCCER | CREW | CITY |
|---|---|---|---|---|
| CIF BASE | 1.29% | 0.86% | 4.42% | 0.70% |
| CIF FGS 1 | 0.36% | 0.33% | 0.90% | −0.06% |
| CIF FGS 2 | 1.34% | 0.64% | 2.03% | 0.16% |
| CIF FGS 3 | 3.87% | 1.49% | 0.73% | 0.98% |
| total (QCIF + CIF) | 1.90% | 0.88% | 1.00% | 0.50% |

As shown in Table 2, a maximum bit rate reduction of 4.42% (in the case of a ‘CREW’ sequence) is obtained in the base layer and bit rate reduction can also be achieved in the FGS layers.

### Experiment 2

Experiment 2 is implemented with the same conditions as those of Experiment 1 except that a frame rate of the QCIF layer increases from 15 fps to 30 fps.

TABLE 3

| Layer | BUS | SOCCER | CREW | CITY |
|---|---|---|---|---|
| CIF BASE | 4.44% | 1.91% | 8.70% | 2.46% |
| CIF FGS 1 | 0.16% | 0.43% | 1.97% | 0.18% |
| CIF FGS 2 | 1.25% | 1.74% | 7.29% | 0.52% |
| CIF FGS 3 | 5.89% | 4.63% | 4.11% | 2.74% |
| total (QCIF + CIF) | 2.42% | 2.36% | 3.38% | 1.14% |

As shown in Table 3, bit rate reduction can also be seen in the base layer and the FGS layers in experiment 2. When the frame rate of the QCIF layer is doubled, a bit rate reduction is further improved.

### Experiment 3

Experiment 3 is implemented with the same conditions as those of Experiment 1 except that the QP of the QCIF layer is increased by 3 or 6. Table 4A shows results when the QP increases by 3 and Table 4B shows results when the QP increases by 6.

TABLE 4A

| Layer | BUS | SOCCER | CREW | CITY |
|---|---|---|---|---|
| CIF BASE | 2.04% | 0.80% | 3.53% | 0.92% |
| CIF FGS 1 | −0.16% | 0.09% | 1.30% | 0.08% |
| CIF FGS 2 | 1.14% | 0.69% | 1.78% | −0.10% |
| CIF FGS 3 | 2.89% | 1.76% | 0.53% | 1.40% |
| total (QCIF + CIF) | 1.63% | 1.01% | 0.89% | 0.68% |

TABLE 4B

| Layer | BUS | SOCCER | CREW | CITY |
|---|---|---|---|---|
| CIF BASE | 6.85% | 1.91% | 8.70% | 2.46% |
| CIF FGS 1 | 0.16% | 0.43% | 1.97% | 0.18% |
| CIF FGS 2 | 1.25% | 1.74% | 7.29% | 0.52% |
| CIF FGS 3 | 5.89% | 4.63% | 4.11% | 2.74% |
| total (QCIF + CIF) | 2.42% | 2.36% | 3.38% | 1.14% |

As shown in Table 4A and Table 4B, it can also be seen that bit rate reduction can be achieved in the base layer and the FGS layers when the QP of the QCIF layer increases.

According to the experimental results, the coding efficiency of a bitstream can be improved by using motion data (motion vector) of an FGS layer. Such improvement may differ with content and bitstream configuration.

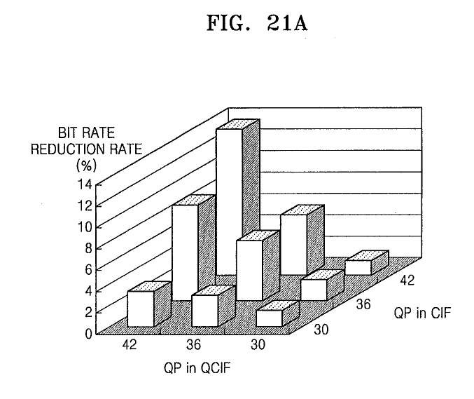

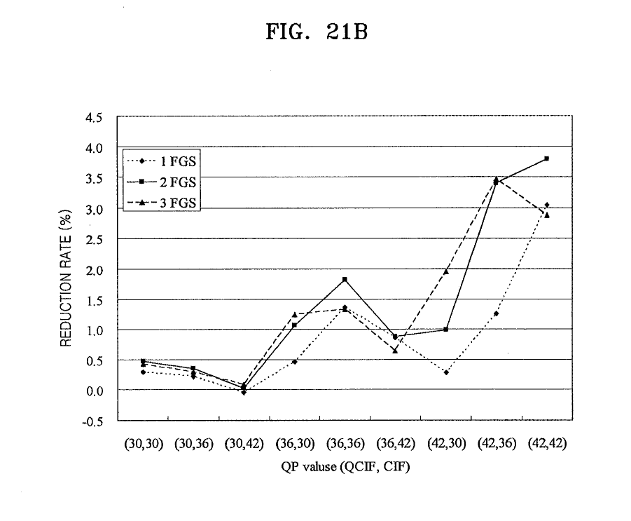

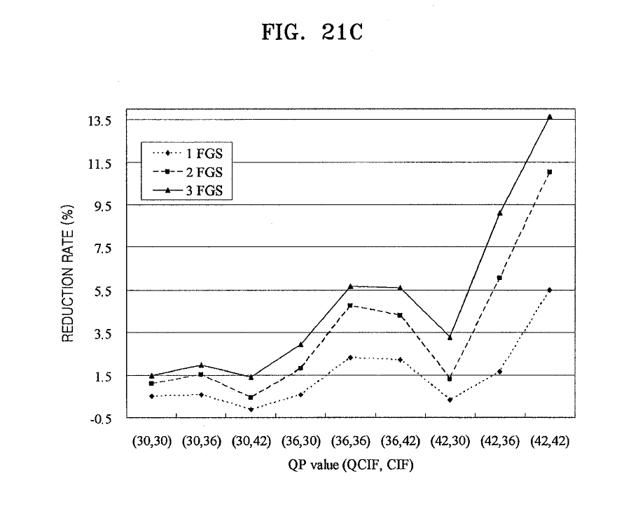

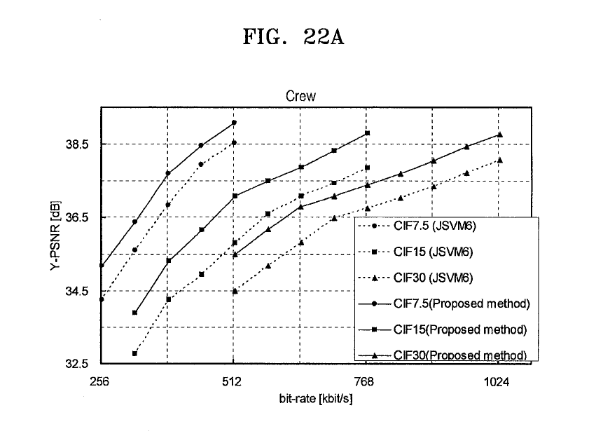

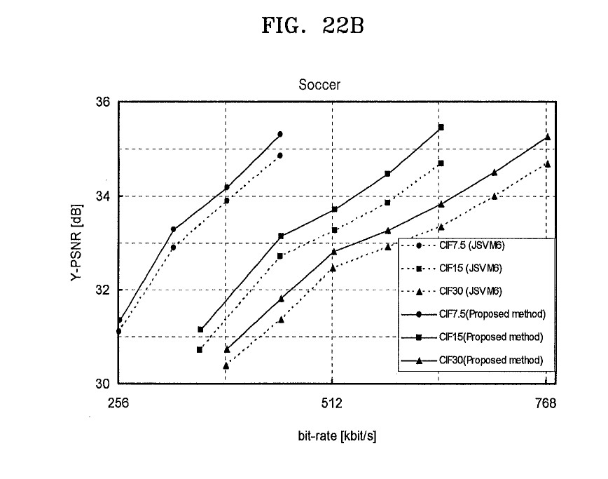

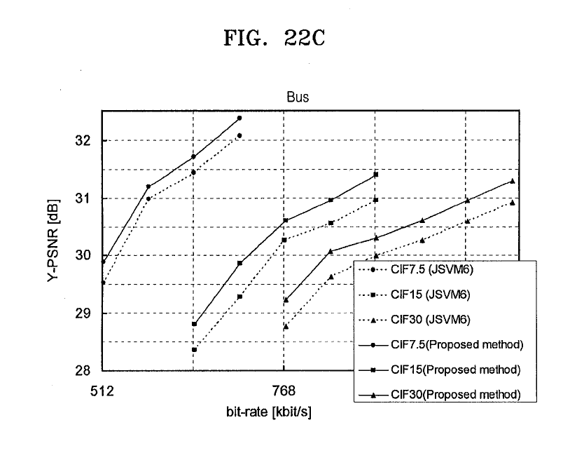

FIGS. 21A to 21C are graphs showing an average bit rate reduction rate in a CIF layer during interlayer motion prediction using motion data of an FGS layer when compared to a conventional art. In FIGS. 21A to 21C, the size of each GOP is 16 and a bitstream is encoded into a QCIF layer at 15 fps which includes 3 FGS layers and a CIF layer at 30 fps.

FIG. 21A shows an average bit rate of a CIF layer according to increases in the QPs of the QCIF layer and the CIF layer, FIG. 21B shows an average bit rate of a bitstream according to the number of FGS layers of the QCIF layer, and FIG. 21C shows an average bit rate of the CIF layer according to the number of FGS layers of the QCIF layer.

It can be seen from FIG. 21A that the average bit rate of the CIF layer is reduced as the QPs of the QCIF layer and the CIF layer increase. It can also be seen from FIGS. 21B and 21C that a bit rate reduction effect becomes larger as the number of FGS layers increases.

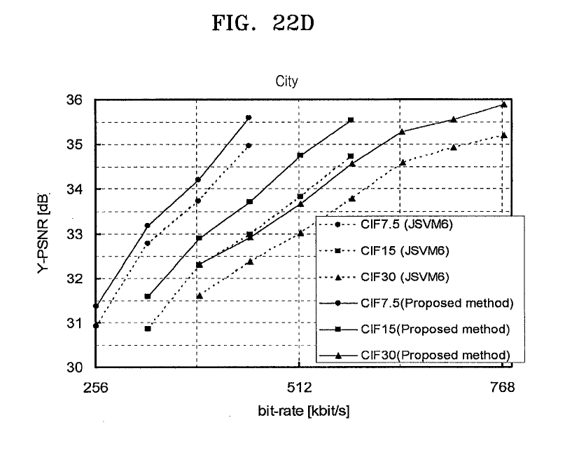

FIGS. 22A to 22D are graphs showing rate-distortion (RD) curves in conventional interlayer motion prediction and in interlayer motion prediction using motion data of an FGS layer. In FIGS. 22A to 22D, the size of each GOP is 16 and a bitstream is encoded into a QCIF layer at 15 fps which includes 3 FGS layers and a CIF layer at 30 fps. The QPs of the QCIF layer and the CIF layer are 42.

FIGS. 22A to 22D are the graphs showing the RD curves when conventional JSVIM 6 and the present invention are applied to a “CREW” sequence, a “SOCCER” sequence, a “BUS” sequence, and a “CITY” sequence. In each graph, the x-axis indicates a bit rate and the y-axis indicates Y-PSNR as a peak signal-to-noise signal (PSNR) of a Y component of a YUV signal of a video. It can be seen from FIGS. 22A to 22D that encoding efficiency corresponding to interlayer motion prediction using motion data of an FGS layer according to the present invention is superior to that corresponding to conventional interlayer motion prediction.

The present invention can also be embodied as a computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (transmission over the Internet). The computer-readable recording medium can also be distributed over network coupled computer systems so that the computer-readable code is stored and executed in a distributed fashion. Also, function programs, codes, and code segments for implementing the present invention can be easily construed by those skilled in the art.

The present invention has been particularly shown and described with reference to exemplary embodiments thereof. Terms used herein are only intended to describe the present invention and are not intended to limit any meaning or the scope of the present invention claimed in the claims.

Therefore, it will be understood by those of ordinary skill in the art that various changes in form and details may be made therein without departing from the spirit and scope of the present invention as defined by the following claims. Accordingly, the disclosed embodiments should be considered in a description sense not in a restrictive sense. The scope of the present invention will be defined by the appended claims, and differences within the scope should be construed to be included in the present invention.

1. A scalable video encoding method comprising:
(a) transforming and quantizing a lower spatial layer of the original video;
(b) performing motion prediction on an higher spatial layer of the original video using motion data of a fine granular scalability (FGS) layer in the transformed and quantized lower spatial layer; and
(c) encoding the transformed and quantized lower spatial layer and the motion predicted higher spatial layer.

2. The scalable video encoding method of claim 1, wherein (b) comprises:
(b1) reconstructing the motion data of the transformed and quantized FGS layer; and
(b2) performing interlayer motion prediction by removing motion data that is redundant with the reconstructed motion data of the FGS layer from the higher spatial layer.

3. The scalable video encoding method of claim 2, wherein (b2) comprises:
(b21) up-sampling the reconstructed motion data to the resolution of the higher spatial layer; and
(b22) removing the motion data that is redundant with the up-sampled motion data from the higher spatial layer.

4. The scalable video encoding method of claim 1, wherein the motion prediction of the higher spatial layer is performed for each frame that temporally corresponds to each frame of the FGS layer.

5. The scalable video encoding method of claim 1, further comprising (d) inserting signaling information indicating that the FGS layer has been used for the motion prediction of the higher spatial layer into a bitstream including the encoded lower spatial layer and the encoded higher spatial layer.

6. The scalable video encoding method of claim 5, wherein (d) comprises inserting the signaling information indicating that the FGS layer has been used for the motion prediction of the higher spatial layer into a payload of the bitstream.

7. The scalable video encoding method of claim 6, wherein the signaling information is a flag inserted into each block of the motion predicted higher spatial layer.

8. The scalable video encoding method of claim 6, wherein the signaling information is SEI metadata inserted before an IDR frame of the motion predicted higher spatial layer.

9. The scalable video encoding method of claim 6, wherein the signaling information is SEI metadata regarding a motion data offset, which is inserted before an FGS NAL unit of the encoded FGS layer.

10. The scalable video encoding method of claim 5, wherein (d) comprises inserting the signaling information indicating that the FGS layer has been used for the motion prediction of the higher spatial layer into a header of the bitstream.

11. The scalable video encoding method of claim 10, wherein the signaling information is a flag inserted into a header of an NAL unit containing the motion data of the FGS layer.

12. The scalable video encoding method of claim 10, wherein the signaling information is a particular value indicating priority, which is inserted into a header of an NAL unit containing the motion data of the FGS layer.

13. The scalable video encoding method of claim 10, wherein the signaling information is a flag inserted into a slice header of the motion predicted higher spatial layer.

14. The scalable video encoding method of claim 5, further comprising:
(e) extracting the signaling information from the bitstream; and
(f) determining whether to remove the FGS layer based on the extracted signaling information and extracting a bitstream having a variable scalability.

15. A scalable video encoding method comprising:
(a) transforming and quantizing a lower spatial layer of the original video;
(b) performing motion prediction on an higher spatial layer of the original video using motion data of one of a base layer and a fine granular scalability (FGS) layer in the transformed and quantized lower spatial layer, which has a smaller estimate value of a bit rate generated during interlayer motion prediction; and
(c) encoding the transformed and quantized lower spatial layer and the motion predicted higher spatial layer.

16. The scalable video encoding method of claim 15, wherein (b) comprises:
(b1) reconstructing the motion data of one of the base layer and the FGS layer, which has a smaller estimate value of a bit rate generated during interlayer motion prediction; and
(b2) performing interlayer motion prediction by removing motion data that is redundant with the reconstructed motion data of the FGS layer from the higher spatial layer.

17. The scalable video encoding method of claim 16, wherein (b1) comprises:
(b11) up-sampling a motion vector of each of the base layer and the FGS layer to the resolution of the higher spatial layer;
(b12) calculating a bit rate generated during interlayer motion prediction using each of the up-sampled motion vectors; and
(b13) selecting one of the base layer and the FGS layer that has the smaller bit rate as a prediction layer.

18. The scalable video encoding method of claim 17, wherein (b1) further comprises (b14) selecting the base layer as the prediction layer if the calculated bit rates are the same.

19. The scalable video encoding method of claim 15, wherein the motion prediction of the higher spatial layer is performed for each frame that temporally corresponds to each frame of the FGS layer.

20. The scalable video encoding method of claim 15, further comprising (d) if the FGS layer has been used for the motion prediction of the higher spatial layer, inserting signaling information indicating that the FGS layer has been used for the motion prediction of the higher spatial layer into a bitstream including the encoded lower spatial layer and the encoded higher spatial layer.

21. The scalable video encoding method of claim 20, further comprising:
(e) extracting the signaling information from the bitstream; and
(f) determining whether to remove the FGS layer based on the extracted signaling information and extracting a bitstream having a variable scalability.

22. A bitstream extraction method comprising:
(a) receiving a bitstream including signaling information indicating that a fine granular scalability (FGS) layer in a lower spatial layer has been used for motion prediction of an higher spatial layer;
(b) extracting the signaling information from the bitstream; and
(c) extracting a bitstream having a variable scalability based on the signaling information.

23. The bitstream extraction method of claim 22, wherein (b) comprises extracting the signaling information from a payload or a header of the bitstream.

24. The bitstream extraction method of claim 22, wherein (c) comprises extracting the bitstream without removing the FGS layer that temporally corresponds to each block of the higher spatial layer if the signaling information is a flag inserted into each block of the higher spatial layer and the flag is set.

25. The bitstream extraction method of claim 22, wherein (c) comprises extracting the bitstream without removing the FGS layer that temporally corresponds to frames from an IDR frame of the higher spatial layer to a frame immediately previous to a next IDR frame if the signaling information is SEI metadata inserted before the IDR frame of the higher spatial layer.

26. The bitstream extraction method of claim 22, wherein (c) comprises extracting the bitstream without removing the start byte of an NAL unit of the FGS layer through the last byte including motion data if the signaling information is SEI metadata regarding a motion data offset, inserted before the NAL unit.

27. The bitstream extraction method of claim 22, wherein (c) comprises extracting the bitstream without removing an NAL unit containing the motion data of the FGS layer if the signaling information is a flag inserted into a header of the NAL unit and the flag is set.

28. The bitstream extraction method of claim 22, wherein (c) comprises extracting the bitstream without removing an NAL unit containing the motion data of the FGS layer if the signaling information is a particular value indicating priority, which is inserted into a header of the NAL unit.

29. The bitstream extraction method of claim 22, wherein (c) comprises extracting the bitstream without removing the FGS layer that temporally corresponds to a slice if the signaling information is a flag inserted into a header of the slice of the higher spatial layer and the flag is set.

30. A scalable video decoding method comprising:
(a) receiving a bitstream having a variable scalability, which includes signaling information indicating that a fine grain scalability (FGS) layer in a lower spatial layer has been used for motion prediction of an higher spatial layer;
(b) decoding the lower spatial layer; and
(c) decoding the higher spatial layer using the decoded lower spatial layer based on the signaling information.

31. The scalable video decoding method of claim 30, further comprising, prior to (a):
(a1) receiving the bitstream including the signaling information;
(a2) extracting the signaling information from the bitstream; and
(a3) determining whether to remove the FGS layer based on the signaling information and extracting the bitstream having a variable scalability.

32. A scalable video encoding apparatus comprising:
a transformation and quantization unit transforming and quantizing a lower spatial layer of the original video;
an interlayer prediction unit performing motion prediction on an higher spatial layer of the original video using motion data of a fine granular scalability (FGS) layer in the transformed and quantized lower spatial layer; and
an encoding unit encoding the transformed and quantized lower spatial layer and the motion predicted higher spatial layer.

33. The scalable video encoding apparatus of claim 32, wherein the interlayer prediction unit comprises:
a reconstruction unit reconstructing the motion data of the transformed and quantized FGS layer; and
a prediction unit performing interlayer motion prediction by removing motion data that is redundant with the reconstructed motion data of the FGS layer from the higher spatial layer.

34. The scalable video encoding apparatus of claim 33, wherein the prediction unit comprises:
an up-sampling unit up-sampling the reconstructed motion data to the resolution of the higher spatial layer; and
a subtraction unit removing the motion data that is redundant with the up-sampled motion data from the higher spatial layer.

35. The scalable video encoding apparatus of claim 32, wherein the motion prediction of the higher spatial layer is performed for each frame that temporally corresponds to each frame of the FGS layer.

36. The scalable video encoding apparatus of claim 32, further comprising a signaling unit inserting signaling information indicating that the FGS layer has been used for the motion prediction of the higher spatial layer into a bitstream including the encoded lower spatial layer and the encoded higher spatial layer.

37. The scalable video encoding apparatus of claim 36, wherein the signaling unit inserts the signaling information indicating that the FGS layer has been used for the motion prediction of the higher spatial layer into a payload of the bitstream.

38. The scalable video encoding apparatus of claim 37, wherein the signaling information is a flag inserted into each block of the motion predicted higher spatial layer.

39. The scalable video encoding apparatus of claim 37, wherein the signaling information is SEI metadata inserted before an IDR frame of the motion predicted higher spatial layer.

40. The scalable video encoding apparatus of claim 37, wherein the signaling information is SEI metadata regarding a motion data offset, which is inserted before an FGS NAL unit of the encoded FGS layer.

41. The scalable video encoding apparatus of claim 36, wherein the signaling unit inserts the signaling information indicating that the FGS layer has been used for the motion prediction of the higher spatial layer into a header of the bitstream.

42. The scalable video encoding apparatus of claim 41, wherein the signaling information is a flag inserted into a header of an NAL unit containing the motion data of the FGS layer.

43. The scalable video encoding apparatus of claim 41, wherein the signaling information is a particular value indicating priority, which is inserted into a header of an NAL unit containing the motion data of the FGS layer.

44. The scalable video encoding apparatus of claim 41, wherein the signaling information is a flag inserted into a slice header of the motion predicted higher spatial layer.

45. The scalable video encoding apparatus of claim 36, further comprising an extractor extracting the signaling information from the bitstream, and determining whether to remove the FGS layer based on the extracted signaling information and extracting a bitstream having a variable scalability.

46. A scalable video encoding apparatus comprising:
a transformation and quantization unit transforming and quantizing a lower spatial layer of the original video;
an interlayer prediction unit performing motion prediction on an higher spatial layer of the original video using motion data of one of a base layer and a fine granular scalability (FGS) layer in the transformed and quantized lower spatial layer, which has a smaller estimate value of a bit rate generated during interlayer motion prediction; and
an encoding unit encoding the transformed and quantized lower spatial layer and the motion predicted higher spatial layer.

47. The scalable video encoding apparatus of claim 46, wherein the interlayer prediction unit comprises:
a reconstruction unit reconstructing the motion data of one of the base layer and the FGS layer, which has a smaller estimate value of a bit rate generated during interlayer motion prediction; and
a prediction unit performing interlayer motion prediction by removing motion data that is redundant with the reconstructed motion data of the FGS layer from the higher spatial layer.

48. The scalable video encoding apparatus of claim 47, wherein the reconstruction unit comprises:
an up-sampling unit up-sampling a motion vector of each of the base layer and the FGS layer to the resolution of the higher spatial layer;
a calculation unit calculating a bit rate generated during interlayer motion prediction using each of the up-sampled motion vectors; and
a selection unit selecting one of the base layer and the FGS layer that has the smaller bit rate as a prediction layer.

49. The scalable video encoding apparatus of claim 48, wherein the selection unit selects the base layer as the prediction layer if the calculated bit rates are the same.

50. The scalable video encoding apparatus of claim 46, wherein the motion prediction of the higher spatial layer is performed for each frame that temporally corresponds to each frame of the FGS layer.

51. The scalable video encoding apparatus of claim 46, further comprising a signaling unit inserting signaling information indicating that the FGS layer has been used for the motion prediction of the higher spatial layer into a bitstream including the encoded lower spatial layer and the encoded higher spatial layer if the FGS layer has been used for the motion prediction of the higher spatial layer.

52. The scalable video encoding apparatus of claim 51, further comprising an extractor extracting the signaling information from the bitstream, and determining whether to remove the FGS layer based on the extracted signaling information and extracting a bitstream having a variable scalability.

53. A bitstream extraction apparatus comprising:
a reception unit receiving a bitstream including signaling information indicating that a fine granular scalability (FGS) layer in a lower spatial layer has been used for motion prediction of an higher spatial layer;
an information extraction unit extracting the signaling information from the bitstream; and
a bitstream extraction unit extracting a bitstream having a variable scalability based on the signaling information.

54. The bitstream extraction apparatus of claim 53, wherein the information extraction unit extracts the signaling information from a payload or a header of the bitstream.

55. The bitstream extraction apparatus of claim 53, wherein the information extraction unit extracts the bitstream without removing the FGS layer that temporally corresponds to each block of the higher spatial layer if the signaling information is a flag inserted into each block of the higher spatial layer and the flag is set.

56. The bitstream extraction apparatus of claim 53, wherein the information extraction unit extracts the bitstream without removing the FGS layer that temporally corresponds to frames from an IDR frame of the higher spatial layer to a frame immediately previous to a next IDR frame if the signaling information is SEI metadata inserted before the IDR frame of the higher spatial layer.

57. The bitstream extraction apparatus of claim 53, wherein the information extraction unit extracts the bitstream without removing the start byte of an NAL unit of the FGS layer through the last byte including motion data if the signaling information is SEI metadata regarding a motion data offset, inserted before the NAL unit.

58. The bitstream extraction apparatus of claim 53, wherein the information extraction unit extracts the bitstream without removing an NAL unit containing the motion data of the FGS layer if the signaling information is a flag inserted into a header of the NAL unit and the flag is set.

59. The bitstream extraction apparatus of claim 53, wherein the information extraction unit extracts the bitstream without removing an NAL unit containing the motion data of the FGS layer if the signaling information is a particular value indicating priority, which is inserted into a header of the NAL unit.

60. The bitstream extraction apparatus of claim 53, wherein the information extraction unit extracts the bitstream without removing the FGS layer that temporally corresponds to a slice if the signaling information is a flag inserted into a header of the slice of the higher spatial layer and the flag is set.

61. A scalable video decoding apparatus comprising:
a reception unit receiving a bitstream having a variable scalability, which includes signaling information indicating that a fine grain scalability (FGS) layer in a lower spatial layer has been used for motion prediction of an higher spatial layer; and
a decoding unit decoding the lower spatial layer and decoding the higher spatial layer using the decoded lower spatial layer based on the signaling information.

62. The scalable video decoding apparatus of claim 61, further comprising an extractor receiving the bitstream including the signaling information, extracting the signaling information from the bitstream, and determining whether to remove the FGS layer based on the signaling information and extracting the bitstream having a variable scalability.

63. A computer-readable recording medium having recorded thereon a program for executing the scalable video encoding method, the bitstream extraction method, and the scalable video encoding method of any one of claims 1 to 31.
